(19) United States
(12) Patent Application Publication
(10) Pub. No.: US 2020/0122693 A1
(43) Pub. Date: Apr. 23, 2020

(54) AUTOMATIC WHEEL CHOCK ASSEMBLY

(71) Applicant: Terry Dolan, Boyers, PA (US)

(72) Inventor: Terry Dolan, Boyers, PA (US)

(21) Appl. No.: 16/167,696

(22) Filed: Oct. 23, 2018

(51) Int. Cl. B60T 3/00; F16D 65/02

(52) U.S. Cl. CPC B60T 3/00; F16D 65/02

(57) ABSTRACT

An automatic wheel chock assembly for parking a trailer includes a trailer that has a plurality of axles, a frame and air brakes. Each of the axles has a wheel that is rotatably coupled thereto. A chock unit is rotatably coupled to the trailer and the chock unit is operationally coupled to the air brakes. The chock unit is actuated into a deployed position when the air brakes are turned on. Thus, the chock unit lowers a stop between the wheel on each of a respective pair of the axles for inhibiting the trailer from rolling. The chock unit is actuated into a stored position when the air brakes are turned off thereby facilitating the wheel on each of the respective pair of axles to roll.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to chock devices and more particularly pertains to a new chock device for parking a trailer.

### BRIEF SUMMARY OF THE INVENTION

An embodiment of the disclosure meets the needs presented above by generally comprising a trailer that has a plurality of axles, a frame and air brakes. Each of the axles has a wheel that is rotatably coupled thereto. A chock unit is rotatably coupled to the trailer and the chock unit is operationally coupled to the air brakes. The chock unit is actuated into a deployed position when the air brakes are turned on. Thus, the chock unit lowers a stop between the wheel on each of a respective pair of the axles for inhibiting the trailer from rolling. The chock unit is actuated into a stored position when the air brakes are turned off thereby facilitating the wheel on each of the respective pair of axles to roll.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an automatic wheel chock assembly according to an embodiment of the disclosure showing a chock unit in a stored position.

FIG. 2 is a perspective view of an embodiment of the disclosure showing a chock unit in a deployed position.

FIG. 3 is a rear view of an embodiment of the disclosure showing a chock unit in a stored position.

FIG. 4 is a rear view of an embodiment of the disclosure showing a chock unit in a deployed position.

### DETAILED DESCRIPTION OF THE INVENTION

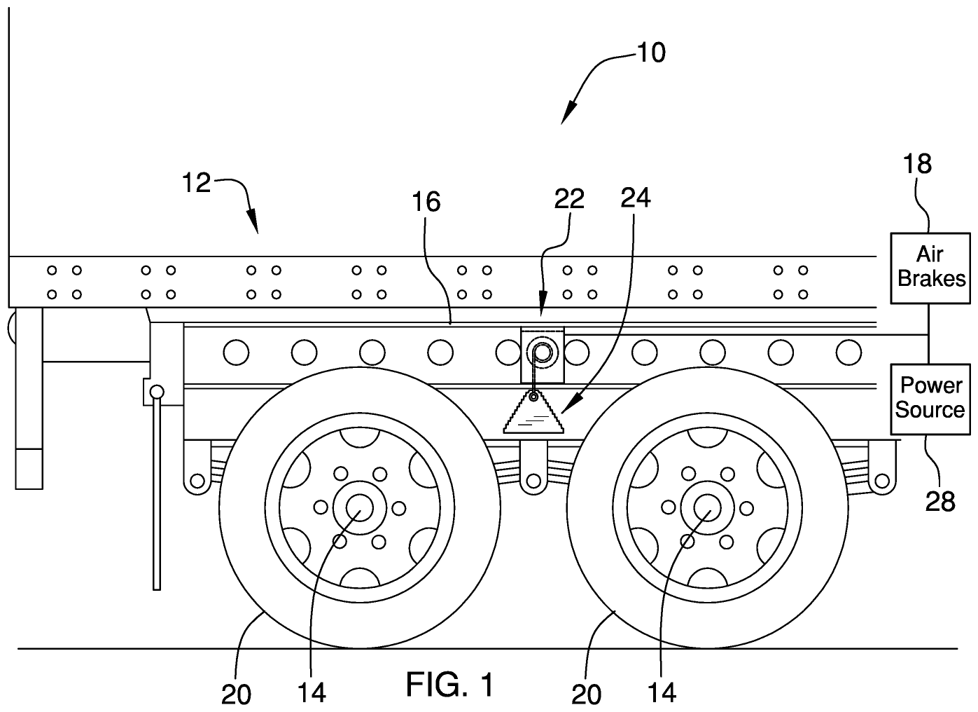

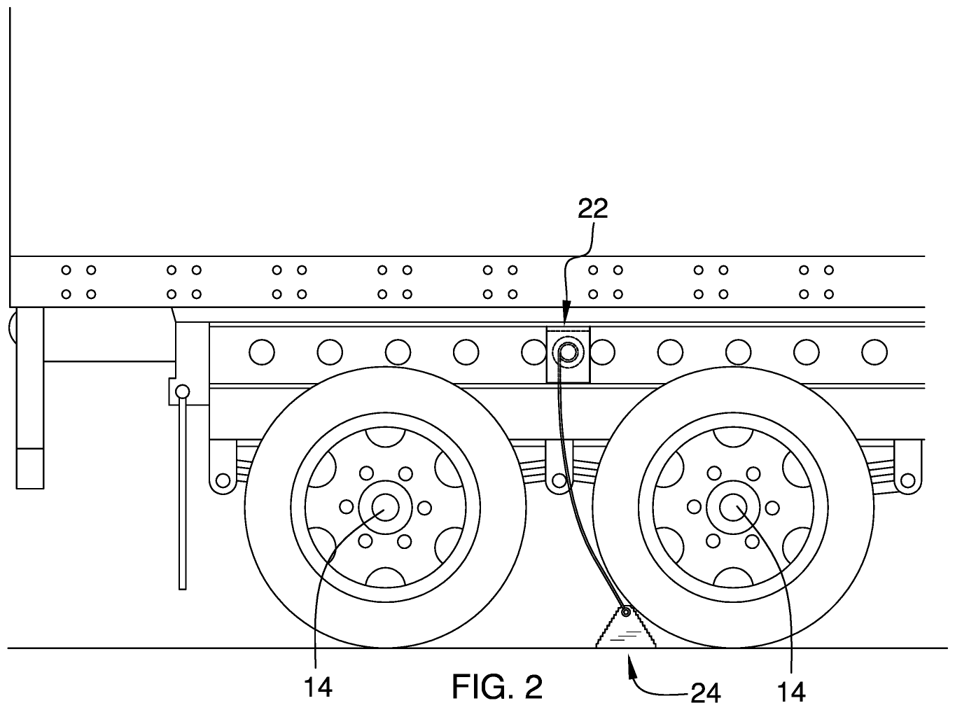

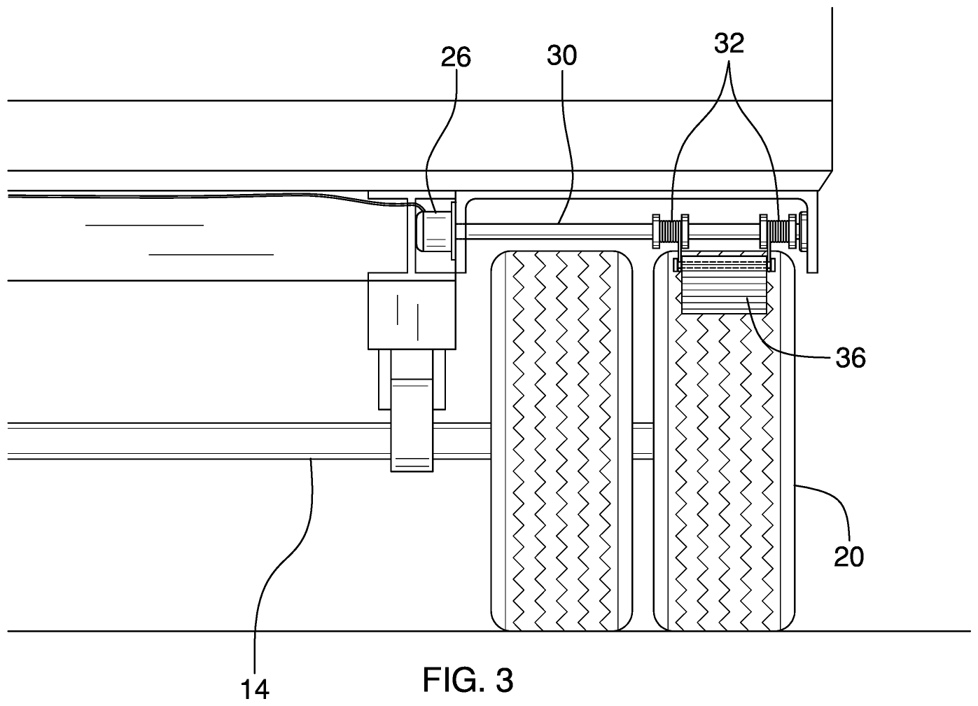

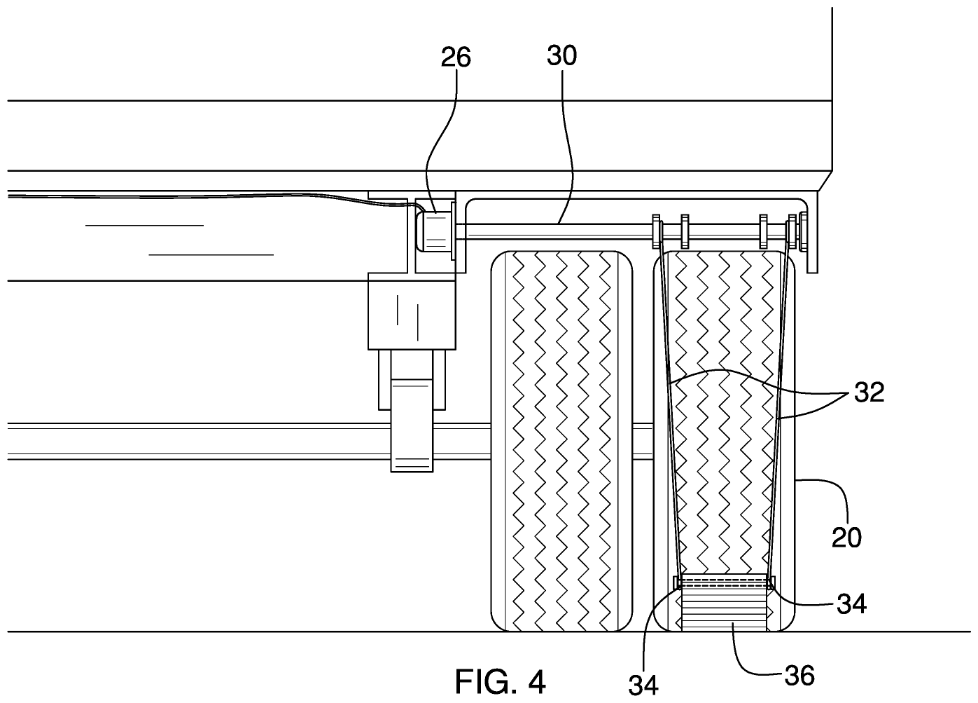

With reference now to the drawings, and in particular to FIGS. 1 through 4 thereof, a new chock device embodying the principles and concepts of an embodiment of the disclosure and generally designated by the reference numeral 10 will be described.

As best illustrated in FIGS. 1 through 4, the automatic wheel chock assembly 10 generally comprises a trailer 12 that has a plurality of axles 14, a frame 16 and air brakes 18. Each of the axles 14 has a wheel 20 that is rotatably coupled thereto. The trailer 12 may be a semi trailer of any conventional design and the trailer 12 may be towed with a semi truck. A chock unit 22 is rotatably coupled to the trailer 12 and the chock unit 22 is operationally coupled to the air brakes 18. Additionally, the air brakes 18 on the trailer 12 are turned on when the parking brake in the semi truck is turned on.

The chock unit 22 is actuated into a deployed position when the air brakes 18 are turned on. Thus, the chock unit 22 lowers a stop 24 between the wheel 20 on each of a respective pair of the axles 14. In this way the trailer 12 is inhibited from rolling thereby enhancing safety for workers loading and unloading the trailer 12. Additionally, the chock unit 22 inhibits the trailer 12 from rolling in the event of air brakes 18 failure. In this way the chock unit 22 enhances safety for individuals that are near the trailer 12 and for vehicles that are parked near the trailer 12. The chock unit 22 is actuated into a stored position when the air brakes 18 are turned off thereby facilitating the wheel 20 on each of the respective pair of axles 14 to roll.

The chock unit 22 comprises a motor 26 that is coupled to the frame 16 of the trailer 12. The motor 26 is electrically coupled to a power source 28 comprising an electrical system of the trailer 12. Moreover, the electrical system of the trailer 12 is in electrical communication with the vehicle that is towing the trailer 12 thereby supply power to the trailer's electrical system. The motor 26 is positioned between the respective pair of axles 14. The motor 26 is turned on to rotate in a first direction when the air brakes 18 are turned on and the motor 26 is turned on to rotate in a second direction when the air brakes 18 are turned off. The motor 26 may be an electric motor 26 or the like.

A spindle 30 is rotatably coupled to the motor 26 and the spindle 30 is positioned above the wheel 20 on each of the respective pair of axles 14. Moreover, the spindle 30 is horizontally oriented and is oriented collinear with the respective axles 14. The spindle 30 may have a pair of pulleys being mounted thereon. The pulleys may be spaced apart from each other and being aligned with the wheel 20 on each of the respective axles 14.

A pair of cables 32 is provided and each of the cables 32 is attached to the spindle 30. Each of the cables 32 is wrapped around the spindle 30 when the motor 26 is turned on to rotate in the second direction. Alternatively, each of the cables 32 is unwrapped from the spindle 30 when the motor 26 is turned on to rotate in the first direction. The cables 32 are spaced apart from each other on the spindle 30 and each of the cables 32 has a distal end 34. Additionally, each of the cables 32 may be positioned around a respective one of the pulleys. Each of the cables 32 is comprised of a weather resistant and break resistant material such as rubber coated steel cable or the like.

The stop 24 comprises a wheel chock 36 that is coupled to the distal end 34 of each of the cables 32. The wheel chock 36 is lowered to ground when the motor 26 is turned on to rotate in the first direction. The wheel chock 36 is positioned between the wheel 20 on each of the respective pair of axles 14 when the wheel chock 36 is lowered. In this way the wheel chock 36 inhibits the trailer 12 from rolling. The wheel chock 36 is lifted from the ground when the motor 26 is turned on to rotate in the second direction thereby facilitating the trailer 12 to roll. The wheel chock 36 may be a wheel chock 36 of any conventional design common to the trucking industry.

In use, the motor 26 is turned on to rotate in the second direction when the air brakes 18 on the trailer 12 are turned on. Thus, the wheel chock 36 is lowered to the ground between the wheel 20 on each of the respective axles 14. In this the wheel chock 36 inhibits the trailer 12 from rolling in the event of air brakes 18 failure or other unexpected event. The motor 26 is turned on to rotate in the first direction when the air brakes 18 on the trailer 12 are turned off. Thus, the wheel chock 36 is lifted from the ground thereby facilitating the trailer 12 to roll.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An automatic wheel chock assembly being configured to be deployed on a trailer when air brakes are applied, said assembly comprising:
a trailer having a plurality of axles, a frame and air brakes, each of said axles having a wheel being rotatably coupled thereto; and
a chock unit being rotatably coupled to said trailer, said chock unit being operationally coupled to said air brakes, said chock unit being actuated into a deployed position when said air brakes are turned on, said chock unit lowering a stop between said wheel on each of a respective pair of said axles for inhibiting said trailer from rolling, said chock unit being actuated into a stored position when said air brakes are turned off thereby facilitating said wheel on each of said respective pair of axles to roll.

2. The assembly according to claim 1, wherein said chock unit comprises a motor being coupled to said frame of said trailer, said motor being electrically coupled to a power source comprising an electrical system of said trailer, said motor being positioned between said respective pair of axles, said motor being turned on to rotate in a first direction when said air brakes are turned on, said motor being turned on to rotate in a second direction when said air brakes are turned off.

3. The assembly according to claim 2, further comprising a spindle being rotatably coupled to said motor having said spindle being positioned above said wheel on each of said respective pair of axles, said spindle being horizontally oriented and being oriented collinear with said respective axles.

4. The assembly according to claim 3, further comprising a pair of cables, each of said cables being attached to said spindle, said cables being spaced apart from each other on said spindle, each of said cables having a distal end.

5. The assembly according to claim 4, wherein:
each of said cables is wrapped around said spindle when said motor is turned on to rotate in said second direction; and
each of said cables is unwrapped from said spindle when said motor is turned on to rotate in said first direction.

6. The assembly according to claim 4, wherein said stop comprises a wheel chock being coupled to said distal end of each of said cables;

7. The assembly according to claim 6, wherein:
said wheel chock is lowered to ground when said motor is turned on to rotate in said first direction having said wheel chock being positioned between said wheel on each of said respective pair of axles wherein said wheel chock thereby inhibiting said trailer from rolling; and
said wheel chock being lifted from the ground when said motor is turned on to rotate in said second direction thereby facilitating said trailer to roll.

8. An automatic wheel chock assembly being configured to be deployed on a trailer when air brakes are applied, said assembly comprising:
a trailer having a plurality of axles, a frame and air brakes, each of said axles having a wheel being rotatably coupled thereto; and
a chock unit being rotatably coupled to said trailer, said chock unit being operationally coupled to said air brakes, said chock unit being actuated into a deployed position when said air brakes are turned on, said chock unit lowering a stop between said wheel on each of a respective pair of said axles for inhibiting said trailer from rolling, said chock unit being actuated into a stored position when said air brakes are turned off thereby facilitating said wheel on each of said respective pair of axles to roll, said chock unit comprising:
a motor being coupled to said frame of said trailer, said motor being electrically coupled to a power source comprising an electrical system of said trailer, said motor being positioned between said respective pair of axles, said motor being turned on to rotate in a first direction when said air brakes are turned on, said motor being turned on to rotate in a second direction when said air brakes are turned off;
a spindle being rotatably coupled to said motor having said spindle being positioned above said wheel on each of said respective pair of axles, said spindle being horizontally oriented and being oriented collinear with said respective axles;
a pair of cables, each of said cables being attached to said spindle, each of said cables being wrapped around said spindle when said motor is turned on to rotate in said second direction, each of said cables being unwrapped from said spindle when said motor is turned on to rotate in said first direction, said cables being spaced apart from each other on said spindle, each of said cables having a distal end; and
said stop comprising a wheel chock being coupled to said distal end of each of said cables, said wheel chock being lowered to ground when said motor is turned on to rotate in said first direction having said wheel chock being positioned between said wheel on each of said respective pair of axles wherein said wheel chock thereby inhibiting said trailer from rolling, said wheel chock being lifted from the ground when said motor is turned on to rotate in said second direction thereby facilitating said trailer to roll.
